(19) United States
(12) Patent Application Publication
(10) Pub. No.: US 2019/0196839 A1
(43) Pub. Date: Jun. 27, 2019

(54) SYSTEM AND METHOD FOR INCREASING ADDRESS GENERATION OPERATIONS PER CYCLE

(71) Applicant: Advanced Micro Devices, Inc., Santa Clara, CA (US)

(72) Inventors: Christopher Spence Oliver, Austin, TX (US); Hanbing Liu, Austin, TX (US); Christopher James Burke, Austin, TX (US); Michael D. Achenbach, Austin, TX (US)

(73) Assignee: Advanced Micro Devices, Inc., Santa Clara, CA (US)

(21) Appl. No.: 15/853,169

(22) Filed: Dec. 22, 2017

(51) Int. Cl. G06F 9/38; G06F 9/30

(52) U.S. Cl. CPC G06F 9/3855; G06F 9/3005

(57) ABSTRACT

A system and method for increasing address generation operations per cycle is described. In particular, a unified address generation scheduler queue (AGSQ) is a single queue structure which is accessed by first and second pickers in a picking cycle. Picking collisions are avoided by assigning a first set of entries to the first picker and a second set of entries to the second picker. The unified AGSQ uses a shifting, collapsing queue structure to shift other micro-operations into issued entries, which in turn collapses the queue and re-balances the unified AGSQ. A second level and delayed picker picks a third micro-operation that is ready for issue in the picking cycle. The third micro-operation is picked from the remaining entries across the first set of entries and the second set of entries. The third micro-operation issues in a next picking cycle.

### BACKGROUND

A processor generally has associated with it an instruction pipeline which includes fetching, decoding (or dispatching) and executing stages. The decoding stage retrieves an instruction from a fetch queue and allocates entries in address generation scheduler queues (AGSQs). Multiple AGSQs are used to support multiple address generation units (AGUs). The AGSQs contain information about each instruction including whether it is ready for issue. Each AGSQ is sized so that in a first half of a picker cycle, a picker selects the oldest instruction that is ready and in a second half of the picker cycle, the picker reads out the information for the instruction. An issue with multiple AGSQs is that one AGSQ can have more instructions that are ready for picking than the other AGSQ and there is no means for re-balancing the AGSQs. A single larger queue is not used for multiple AGUs because there is not enough time in the cycle to complete a second pick after waiting for completion of the first pick.

### BRIEF DESCRIPTION OF THE DRAWINGS

A more detailed understanding may be had from the following description, given by way of example in conjunction with the accompanying drawings wherein:

FIG. 1 is a conventional distributed scheduler;

FIG. 2 is a high level block and flow diagram of a core processing unit of a processor in accordance with certain implementations;

FIG. 3 is a high level block and flow diagram of a unified address generation scheduler queue in accordance with certain implementations;

FIG. 4 is a high level block and flow diagram of an integer scheduler and/or execution unit in accordance with certain implementations;

FIG. 5 is a high level block and flow diagram of a scheduler and/or execution unit in accordance with certain implementations;

FIG. 6 is a flow and timeline diagram for the unified schedulers described in FIGS. 3-5 in accordance with certain implementations;

FIG. 7 is a flow diagram of a method for increasing address generation operations in accordance with certain implementations;

FIG. 8 is a high level block and flow diagram of a distributed scheduler with increased address generation operations per cycle in accordance with certain implementations; and

FIG. 9 is a block diagram of an example device in which one or more disclosed implementations may be implemented.

### DETAILED DESCRIPTION

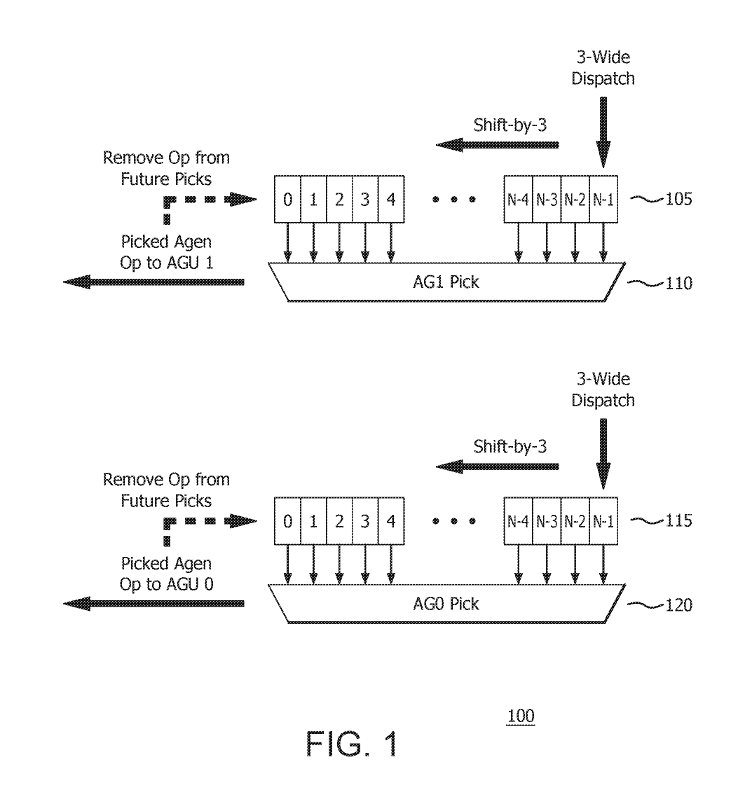

Processors generally operate pursuant to an instruction pipeline which includes fetching, decoding (or dispatching) and executing stages. The decoding or dispatching stage provides micro-operations for processing and allocates entries in address generation scheduler queues (AGSQs) for the micro-operations. A conventional distributed scheduler 100 is shown in FIG. 1 which provides two address generation operations per cycle. The distributed scheduler 100 includes a first AGSQ 105 connected to a first picker 110 and a second AGSQ 115 connected to a second picker 120, where each AGSQ has a queue depth of N. In a picker cycle, the first picker 110 picks the oldest micro-operation that is ready for issue (address generation) from the first AGSQ 105 and the second picker 120 picks the oldest micro-operation that is ready for issue from the second AGSQ 115. The picked micro-operations are then issued to AGU1 and AGU0, respectively, and the issued micro-operations are deallocated from the first AGSQ 105 and the second AGSQ 115, respectively.

The first AGSQ 105 and the second AGSQ 115 can have different numbers of ready micro-operations which leads to unbalanced AGSQs and decreases system performance. For example, if one AGSQ does not have any micro-operations that are ready for issue, then a potential pick in the picking cycle is wasted. However, there is no easy process for re-balancing the first AGSQ 105 and the second AGSQ 115. Moreover, a single larger queue is not used for multiple AGUs because there is not enough time in the cycle to complete a second pick after waiting for completion of the first pick.

A system and method for increasing address generation operations per cycle is described. In particular, a unified AGSQ is a single queue structure which can be accessed by first and second pickers in a picking cycle. Picking collisions are avoided by assigning a first set of entries in the unified AGSQ to the first picker and a second set of entries in the unified AGSQ to the second picker. The unified AGSQ enables re-balancing of the queue after the picking and issuing of the micro-operations to a first and second AGU, respectively. The unified AGSQ uses a shifting, collapsing queue structure to shift other micro-operations into issued entries, which in turn collapses the unified AGSQ. Consequently, the oldest micro-operations that are ready for issue can be picked by the first and second pickers. In an implementation, a second level and delayed picker picks a third micro-operation that is ready for issue in a current picking cycle. The third micro-operation is picked from the remaining entries across the first set of entries and the second set of entries. The third micro-operation issues in a next picking cycle (the “delayed” aspect of the picker) to a third AGU. In this implementation, the first and second pickers are first level pickers.

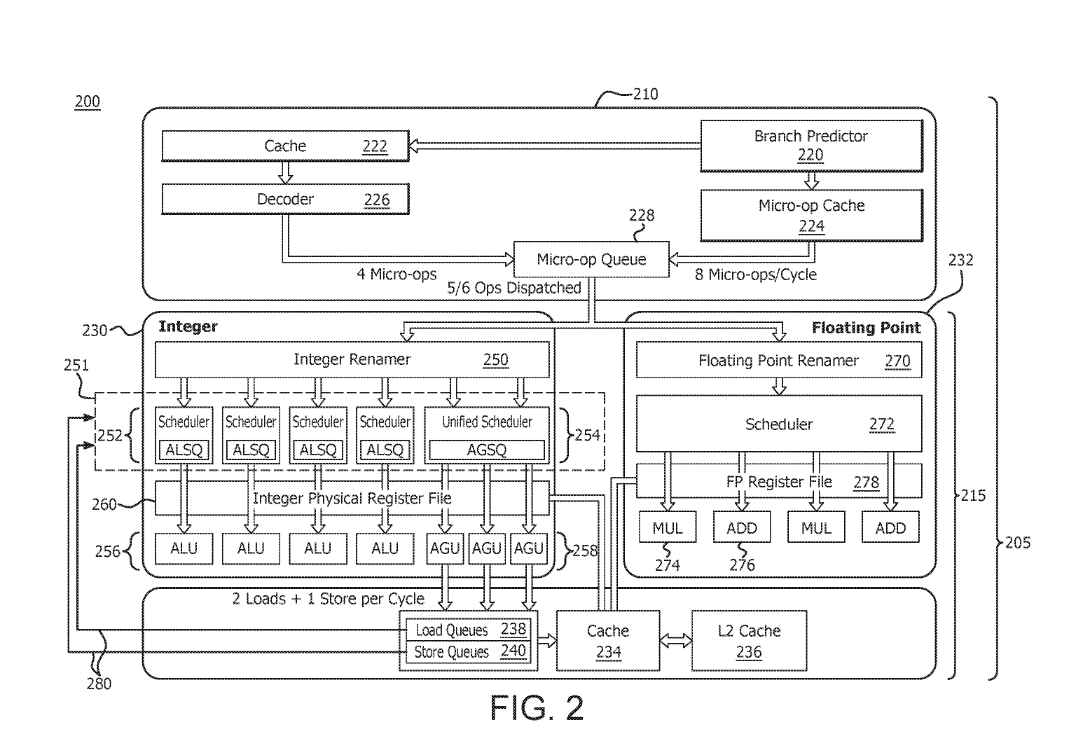

FIG. 2 is a high level block and flow diagram of a core processing unit 205 of a processor 200 in accordance with certain implementations. The core processing unit 205 includes a decoder unit 210 which provides micro-operations (micro-ops) to a scheduler and execution unit (SCEX) 215. The decoder unit 210 includes a branch predictor 220 connected to a cache 222 and a micro-op cache 224. The cache 222 is further connected to a decoder 226. The decoder 226 and the micro-op cache 224 are connected to a micro-op queue 228.

The SCEX 215 includes an integer SCEX 230 and a floating point SCEX 232, both of which are connected to a cache 234. The cache 234 is further connected to a L2 cache 236, load queue (LDQ) 238 and store queue (STQ) 240. The integer SCEX 230 includes an integer renamer 250 which is connected to a scheduler 251, which includes arithmetic logic unit (ALU) scheduler queues (ALSQs) 252 and a unified address generation unit (AGU) scheduler queue (AGSQ) 254. The scheduler 251, and in particular the ALSQs 252 and AGSQ 254, are further connected to ALUs 256 and AGUs 258, respectively. The LDQ 238 and STQ 240 are connected to the scheduler 251 via path 280 to send deallocation signals. The integer SCEX 230 also includes an integer physical file register 260. The floating point SCEX 232 includes a floating point renamer 270, which is connected to a scheduler 272. The scheduler 272 is further connected to multipliers 274 and adders 276. The floating point SCEX 232 also includes a floating point physical file register 278.

A pipelined processor requires a steady stream of instructions to be fed into the pipeline. The branch predictor 220 predicts which set of micro-operations are fetched and executed in the pipelined processor. These micro-operations are fetched and stored in cache 222, which in turn are decoded by the decoder 226. The micro-op cache 224 caches the micro-operations from the branch predictor 220 as the decoder 226 decodes the micro-operations from the cache 222. The micro-op queue 228 stores and queues up the micro-operations from the decoder 226 and micro-op cache 224 for purposes of dispatching the micro-operations for execution.

In conventional pipeline processing, as shown in FIG. 1, a micro-op queue dispatches the micro-operations to multiple AGSQs and a pair of pickers select from their respective AGSQs the oldest micro-operations that are ready for issue. However, if a particular AGSQ does not have a micro-operation that is ready for issue, a potential pick in the picking cycle is wasted since the pickers are configured to operate with only an AGSQ and cannot pick from the other AGSQ. There is no process for re-balancing between the AGSQs in the conventional configuration.

In accordance with an implementation, the micro-operations are dispatched to a unified AGSQ 254. The unified AGSQ 254 is a single queue which holds a dispatch payload associated with the micro-operations while the micro-operations are waiting to become ready for issue. The pickers can pick the oldest micro-operations that are ready for issue from the unified AGSQ 254 in parallel. Collisions are avoided by having each picker assigned to non-overlapping sets of AGSQ entries. As the micro-operations are picked, the unified AGSQ 254 re-balances due to the shifting and balancing structure of the AGSQ 254. Consequently, the oldest ready to issue micro-operations will be available for picking. Moreover, the unified AGSQ 254 allows a third picker to pick another micro-operation that is ready for issue in the same picking cycle. The third picker picks from the remaining entries across the combined set of AGSQ entries. This third pick is issued in the next picking cycle. Once the micro-operations are picked, they are processed in the processing pipeline of processor 200.

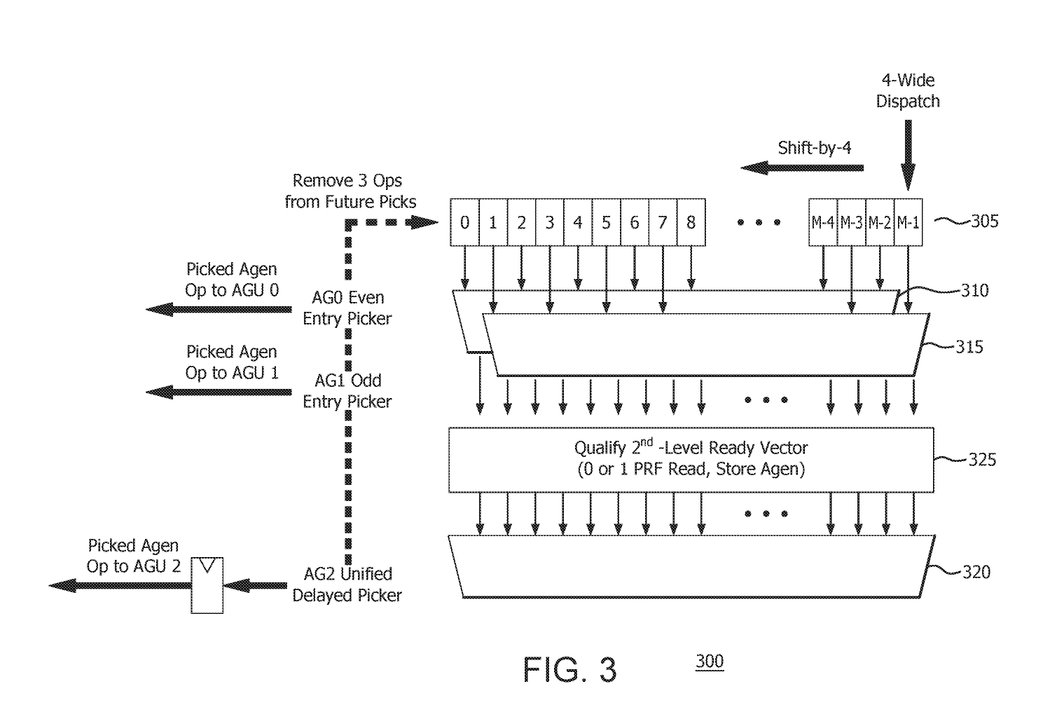

FIG. 3 is a high level block and flow diagram of a unified scheduler 300 in accordance with certain implementations. The unified scheduler 300 includes an AGSQ 305 connected to a first picker 310 and a second picker 315. The AGSQ 305 is a shifting and collapsing queue structure that shifts unpicked entries into previously picked entries. As the shifting occurs, the queue structure collapses, and causes a re-balancing of the unpicked entries. The AGSQ 305 is a single queue of depth M. In an implementation, M may be 2N, i.e., twice the depth of the first AGSQ 105 or the second AGSQ 115 of FIG. 1. The first picker 310 is configured to pick from a set of entries in the AGSQ 305 and the second picker 315 is configured to pick from another set of entries in the AGSQ 305 to avoid picking collisions. In an implementation, the first set of entries may be even entries and the other set of entries may be odd entries. In another implementation, the first set of entries and the other set of entries are distributed based on interdependency between the micro-operations. In another implementation, the first set of entries and the other set of entries are partitioned based on statistical or historical micro-operation information.

In an illustrative example, in a picking cycle, the first picker 310 selects from the even entries in the AGSQ 305 and the second picker 315 selects from the odd entries in the AGSQ 305. In particular, the first picker 310 picks the oldest micro-operation that is ready for issue from the even entries and the AGSQ 305 issues the picked micro-operation to a first AGU0. In the same or current picking cycle, the second picker 315 picks the oldest micro-operation that is ready for issue from the odd entries and the AGSQ 305 issues the picked micro-operation to a second AGU1. In this implementation and illustrative example, the two picked micro-operations are removed from the AGSQ 305 so that they are not picked in the next picking cycle. Consequently, the AGSQ 305 is rebalanced due to the shifting and collapsing queue structure and increases the probability that the oldest micro-operations that are ready to issue will be picked.

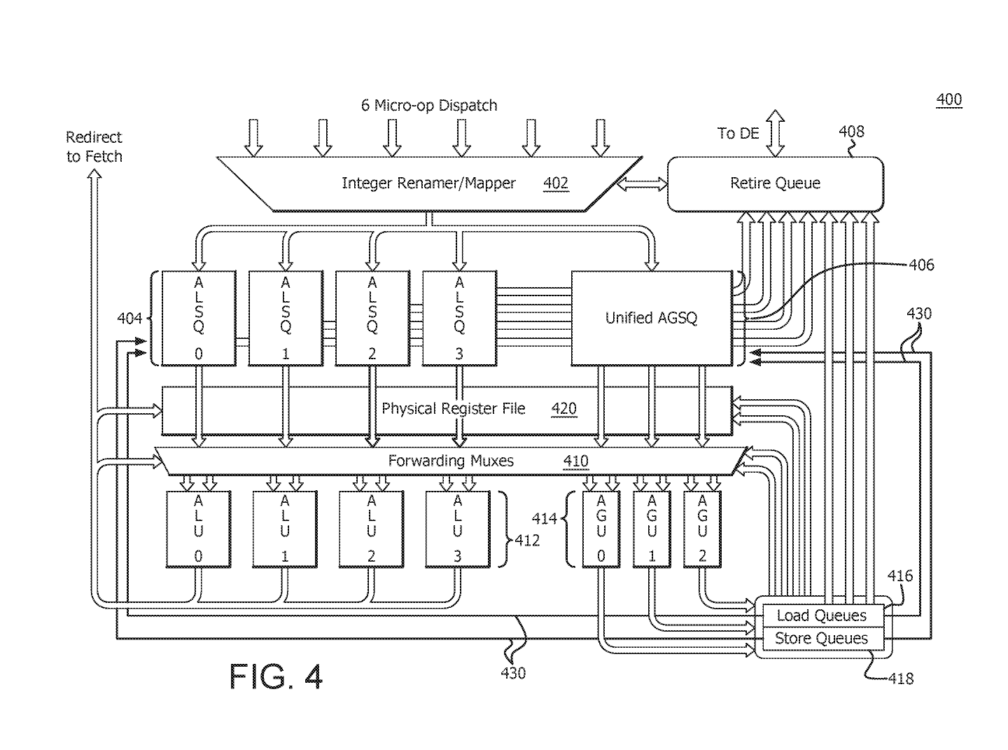

Still referring to FIG. 3, in an implementation, a third picker 320 can pick a third oldest micro-operation that is ready for issue from a ready vector 325 generated after the first picker 310 and the second picker 315 have made their picks. The ready vector 325 is generated from the remaining entries in the even entries in the AGSQ 305 and from the odd entries in the AGSQ 305. The third pick still occurs in the current picking cycle. The AGSQ 305 issues the picked micro-operation in a next picking cycle to a third AGU2. In this implementation and illustrative example, the three picked micro-operations are removed from the AGSQ 305 so that they are not picked in the next picking cycle. In an implementation of the third picker 320, the third picked micro-operation is a store micro-operation. In another implementation, a potential micro-operation is eligible for the third picker 320 if the micro-operation needs 0 or 1 sources from a physical register file (see PRF 420 in FIG. 4). The micro-operation may get 1 or 2 sources from a bypass network (shown as forwarding multiplexers 410 in FIG. 4). Implementations including the third picker 320 effectively provide three address generation operations per cycle.

FIG. 4 is a high level block diagram of an integer scheduler/execution unit 400 in accordance with certain implementations. The integer scheduler/execution unit 400 includes an integer renamer/mapper 402 which is connected to ALSQs 404, AGSQ 406 and a retire queue 408. The ALSQs 404 and AGSQ 406 are further connected to forwarding multiplexors 410, which in turn are connected to ALU₀-ALU₃ 412, LDQ 416 and STQ 418. The AGU₀-AGU₂ 414 are connected to LDQ 416 and STQ 418. The integer scheduler/execution unit 400 also includes a physical file register 420 that is connected to ALU₀-ALU₃ 412, LDQ 416 and STQ 418. The LDQ 416 and STQ 418 are connected to AGSQ 406 via path 430 to send deallocation signals and to retire queue 408.

Similar to FIGS. 2 and 3, micro-operations are dispatched to the AGSQ 406. The AGSQ 406 holds the dispatch payload until the required source information and an appropriate load queue or store queue entry is available. In a picking cycle, a first picker picks the oldest micro-operation that is ready to issue from a first set of entries and a second picker picks the oldest micro-operation that is ready to issue from a second set of entries, where the first set of entries and the second set of entries do not overlap to avoid picking collisions. The AGSQ 406 issues the picked micro-operations to the AGU₀-AGU₁ 414, respectively. In an implementation, a third picker picks a next oldest micro-operation that is ready to issue from a ready vector generated after the first two pickers have completed their picks. In the next picking cycle, the AGSQ 406 issues the third picked micro-operation to the AGU₂ 414. In an implementation, if the third picker is resource-constrained by the number of available read ports in the physical register file 420, the third picker can leverage knowledge of any source data that will be in the forwarding multiplexers 410 just before the micro-operation executes. Thus more micro-operations can qualify for selection by this third picker, improving the probability of being picked sooner.

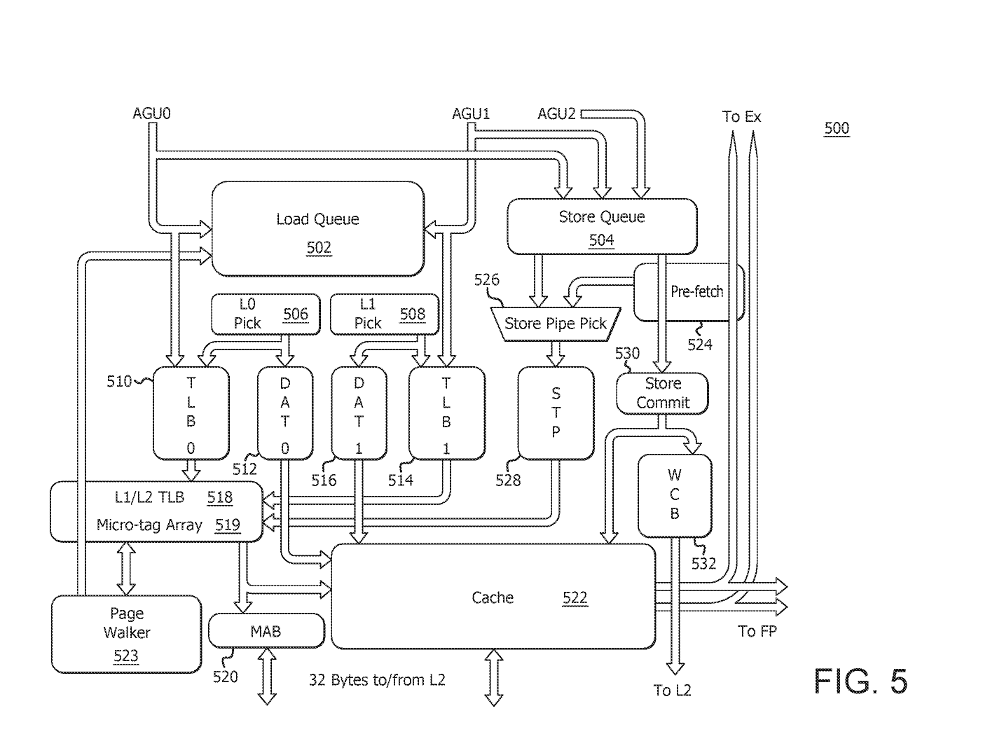

FIG. 5 is a high level block and flow diagram of a load-store/data cache (LSDC) unit 500 in accordance with certain implementations. The LSDC unit 500 includes a LDQ 502, a STQ 504, a load 0 (L0) picker 506 and a load 1 (L1) picker 508. The L0 picker 506 is connected to a translation lookaside buffer (TLB) and micro-tag access pipeline 0 (TLB0) 510 and a data cache access pipeline (data pipe 0) 512. The L1 picker 508 is connected to a translation lookaside buffer (TLB) and micro-tag access pipeline 1 (TLB1) 514 and a data cache access pipeline (data pipe 1) 516. The TLB0 510 and TLB1 514 are further connected to L1/L2 TLB 518, a page walker 523, and micro-tag array 519, which in turn is connected to a miss address buffer (MAB) 520, and assists in reading data from a cache 522. The data pipe 0 512 and data pipe 1 516 are connected to the cache 522. The STQ 504 is connected to a pre-fetcher 524 and a store pipe picker 526, which in turn is connected to a store pipeline (STP) 528. The STP 528 is also connected to the L1/L2 TLB 518 and the micro-tag array 519. The STQ 504 is further connected to a store commit pipeline 530, which in turn is connected to a write combining buffer (WCB) 532 and the cache 522.

Once the micro-operations are picked, the unified AGSQ issues the picked micro-operations to AGU0, AGU1 and AGU2, which in turn instructs the LDQ 502 and STQ 504 as appropriate. In an implementation, the third picker picks store micro-operations and the AGU2 instructs STQ 504 only. Accordingly, once address generation is performed by the unified AGSQ and the dispatch payload are held in the LDQ 502 and STQ 504 as appropriate, the LSDC 500 executes the micro-operations. In an illustrative example, when a load micro-operation is picked (such as at L0 picker 506 or L1 picker 508), the load micro-operation uses the respective TLB 0 510 or TLB 1 514 pipelines to check for a translation and a predicted data cache way for the load micro-operation. The load micro-operation also checks the cache 522 via data pipe 0 512 and data pipe 1 516, respectively. In certain implementations, micro-tag array 519 allows a micro-operation to determine a predicted data cache way prior to confirming the way by comparing with the full tags. The page walker 523 is used to determine the physical address of the micro-operations. In another illustrative example, the pre-fetcher 524 is used to populate lines in the cache 522 prior to a request being sent to the cache 522.

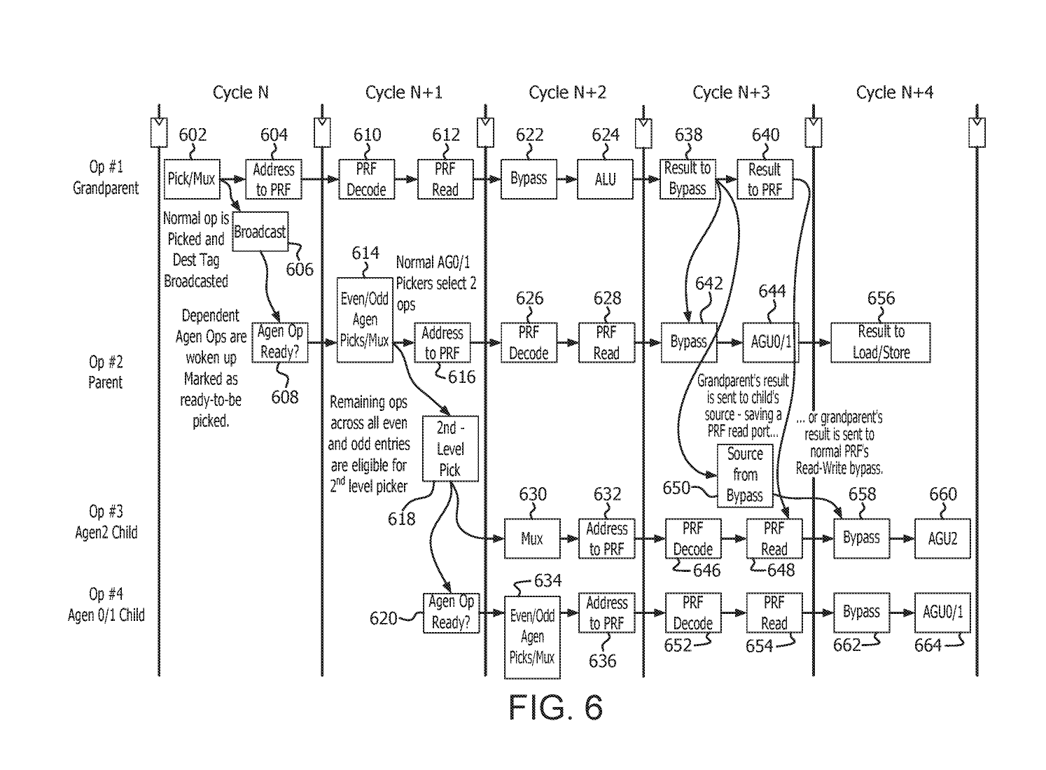

FIG. 6 is a flow and timeline diagram 600 for the unified schedulers described in FIGS. 3-5 in accordance with certain implementations. Lineage denotes dependence of child micro-operations' source data, which is the result data of their parent micro-operation(s). In turn, those parent's source data was produced by the grandparent's result data. In picking cycle N, a picker selects an oldest micro-operation that is ready to issue from the AGSQ (action 602), sends the address associated with the micro-operation to a physical register file (PRF) (action 604) and broadcasts a destination address for the picked micro-operation (action 606). Moreover, micro-operations that are dependent on the picked micro-operation are awoken and marked as ready (action 608).

In picking cycle N+1, the PRF decodes the address (action 610) and reads the data associated with the decoded address (action 612) for the picked micro-operation with respect to Op#1 Grandparent. First and second pickers select the oldest micro-operations that are ready to issue from the AGSQ (action 614) and send the addresses to the PRF (action 616). A third picker picks the next oldest micro-operation that is ready to issue from among the remaining micro-operations in the AGSQ (action 618). The picked micro-operations are blocked from being picked in cycle N+2 with respect to Op#4 Agen 0/1 Child (action 620).

In picking cycle N+2, the PRF sends the data via a Bypass (action 622) to an ALU for processing (action 624) with respect to Op#1 Grandparent. The PRF decodes the address (action 626) and reads the data associated with the decoded address (action 628) for the picked micro-operation with respect to Op#2 Parent. The pick from the third picker is issued via multiplexers (action 630) and the address is sent to the PRF (action 632) with respect to Op#3 Agen2 Child. The first and second pickers select the oldest micro-operations that are ready to issue from the AGSQ (action 634) and send the addresses to the PRF (action 636) with respect to Op#4 Agen 0/1 Child.

In picking cycle N+3, the ALU sends the results to the Bypass (action 638) and to the PRF (action 640) with respect to Op#1 Grandparent. The Bypass receives results from Op#1 Grandparent and from the PRF with respect to Op#2 Parent (action 642). The Bypass forwards the results to AGU0/1 for processing (action 644). The PRF decodes the address (action 646) and reads the appropriate data (action 648). The results from Op#1 Grandparent are sent to the Source via the bypass (action 650) or the results are sent from the PRF of the Op#1 Grandparent to the Op#3 Agen2 Child (action 648). The PRF decodes the address (action 652) and reads the data associated with the decoded address (action 654) for the picked micro-operation with respect to Op#4 Agen 0/1 Child.

In picking cycle N+4, The AGU 0/1 sends the results to the load/store unit (action 656) with respect to Op#2 Parent. The Bypass receives the data from the Source (action 658) and sends the data to the AGU₂ for processing (action 660) with respect to Op#3 Agen2 Child. The Bypass receives the data from the PRF (action 662) and sends the data to the AGU0/1 for processing (action 664) with respect to Op#4 Agen0/1 Child.

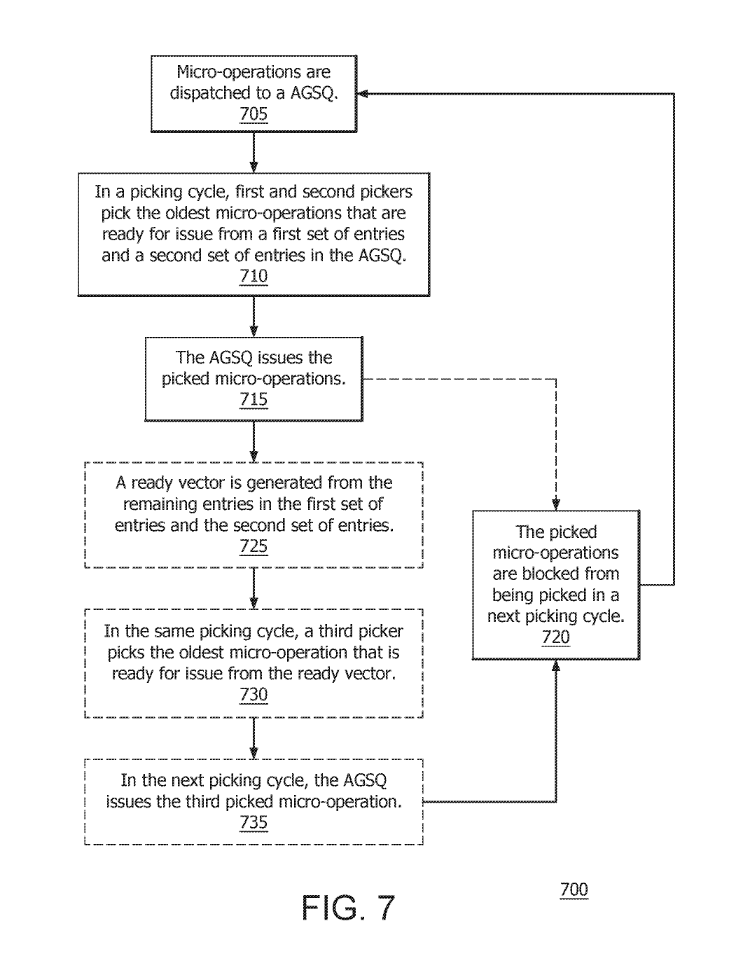

FIG. 7 is a flow diagram 700 of a method for increasing address generation operations in accordance with certain implementations. Micro-operations are dispatched to an AGSQ (step 705). In a picking cycle, first and second pickers pick the oldest micro-operations that are ready for issue from a first set of entries and a second set of entries in the AGSQ (step 710). The first set of entries and the second set of entries in the AGSQ are non-overlapping. In an implementation, the first set of entries can be odd (or even) entries and the second set of entries can be even (or odd) entries. The AGSQ issues the picked micro-operations (step 715). In an implementation, the picked micro-operations are blocked from being picked in a next picking cycle (step 720). The order of operations is illustrative only and other orders can be used.

In an implementation, a ready vector is generated from the remaining entries in the first set of entries and the second set of entries (step 725). In the same picking cycle, a third picker picks the oldest micro-operation that is ready for issue from the ready vector (step 730). The picked micro-operations are blocked from being picked in a next picking cycle (step 720). In the next picking cycle, the AGSQ issues the third picked micro-operation (step 735). The order of operations is illustrative only and other orders can be used.

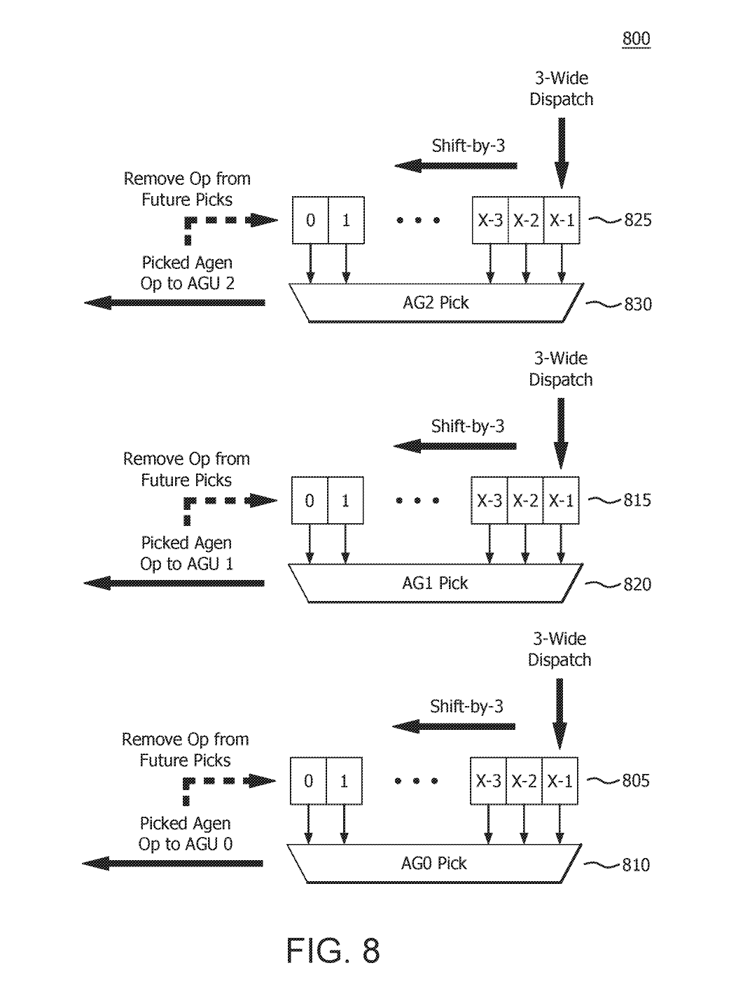

FIG. 8 is a high level block and flow diagram of a distributed scheduler 800 with three address generation operations per cycle in accordance with certain implementations. The distributed scheduler 800 includes a first AGSQ 805 connected to a first picker 810, a second AGSQ 815 connected to a second picker 820, and a third AGSQ 825 connected to a third picker 830. Each AGSQ has a queue depth of X, where X may equal to 2*N/3 relative to the distributed scheduler 100. In a picker cycle, the first picker 810 picks the oldest micro-operation that is ready for issue from the first AGSQ 805, the second picker 820 the oldest micro-operation that is ready for issue from the second AGSQ 815 and the third picker 830 picks the oldest micro-operation that is ready for issue from the third AGSQ 825. The picked micro-operations are then issued to AGU0, AGU1 and AGU2, respectively, and the issued micro-operations are deallocated from the first AGSQ 805, the second AGSQ 815, and the third AGSQ 825 respectively.

In an implementation, a third picker can be implemented with a distributed scheduler such as the distributed scheduler 100 of FIG. 1, for example. In an implementation, the third picker can pick the remaining oldest micro-operation that is ready for issue from one of the first AGSQ 105 or the second AGSQ 115 in the picking cycle and the respective first AGSQ 105 or second AGSQ 115 can issue the picked micro-operation in the next picking cycle as described herein. In another implementation, the third picker can pick the remaining oldest micro-operation that is ready for issue from across both the first AGSQ 105 and the second AGSQ 115 in the picking cycle and the respective first AGSQ 105 or second AGSQ 115 can issue the micro-operation in the next picking cycle as described herein. In another implementation, a third and fourth picker can be implemented with the distributed scheduler 100 of FIG. 1. In the picking cycle, the third picker can pick a next oldest micro-operation that is ready for issue from the first AGSQ 105 and the fourth picker can pick a next oldest micro-operation that is ready for issue from the second AGSQ 115. The first AGSQ 105 and the second AGSQ 115 can issue the picked micro-operations in the next picking cycle as described herein.

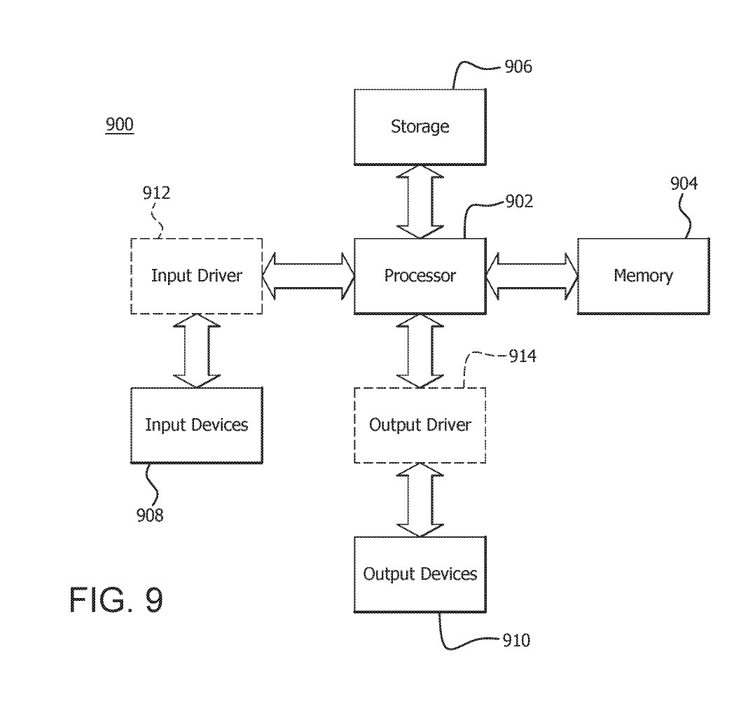

FIG. 9 is a block diagram of an example device 900 in which one or more portions of one or more disclosed examples are implemented. The device 900 includes, for example, a head mounted device, a server, a computer, a gaming device, a handheld device, a set-top box, a television, a mobile phone, or a tablet computer. The device 900 includes a compute node or processor 902, a memory 904, a storage 906, one or more input devices 908, and one or more output devices 910. The device 900 also optionally includes an input driver 912 and an output driver 914. It is understood that the device 900 includes additional components not shown in FIG. 9.

The compute node or processor 902 includes a central processing unit (CPU), a graphics processing unit (GPU), a CPU and GPU located on the same die, or one or more processor cores, wherein each processor core may be a CPU or a GPU. The memory 904 is located on the same die as the compute node or processor 902, or is located separately from the compute node or processor 902. In an implementation, the memory 904 includes a volatile or non-volatile memory, for example, random access memory (RAM), dynamic RAM, or a cache.

The storage 906 includes a fixed or removable storage, for example, a hard disk drive, a solid state drive, an optical disk, or a flash drive. The input devices 908 include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 910 include a display, a speaker, a printer, a haptic feedback device, one or more lights, an antenna, or a network connection (e.g., a wireless local area network card for transmission and/or reception of wireless IEEE 802 signals).

The input driver 912 communicates with the compute node or processor 902 and the input devices 908, and permits the compute node or processor 902 to receive input from the input devices 908. The output driver 914 communicates with the compute node or processor 902 and the output devices 910, and permits the processor 902 to send output to the output devices 910. It is noted that the input driver 912 and the output driver 914 are optional components, and that the device 900 will operate in the same manner if the input driver 912 and the output driver 914 are not present.

In general, a method for processing micro-operations includes dispatching micro-operations to a scheduler queue. The scheduler queue has a first set of entries and a second set of entries which are non-overlapped. An oldest micro-operation that is ready for issue from the first set of entries in the scheduler queue is picked in a picking cycle and an oldest micro-operation that is ready for issue from the second set of entries in the scheduler queue is picked in the picking cycle. The picked micro-operation from the first set of entries is issued in the picking cycle and the picked micro-operation from the second set of entries is issued in the picking cycle. In an implementation, the scheduler queue is a single queue structure. In an implementation, the method further includes blocking the picked micro-operation from the first set of entries and the picked micro-operation from the second set of entries from being picked in a next picking cycle. In an implementation, the method further includes generating a ready vector from micro-operations remaining in the scheduler queue from both the first set of entries and the second set of entries. In an implementation, the method further includes picking an oldest micro-operation that is ready for issue from the ready vector in the picking cycle. In an implementation, the method further includes blocking the picked micro-operation from the first set of entries, the picked micro-operation from the second set of entries and the picked micro-operation from the ready vector from being picked in a next picking cycle. In an implementation, the method further includes issuing the picked micro-operation from the ready vector in a next picking cycle. In an implementation, the first set of entries are even entries and the second set of entries are odd entries. In an implementation, non-overlapped is based on at least one of priority, historical data, and queue position. In an implementation, the scheduler queue is an address generation scheduler queue.

In general, a processor for processing micro-operations includes a micro-operation dispatch unit, a scheduler queue, a first picker and a second picker. The scheduler queue has a first set of entries and a second set of entries which are non-overlapped. The micro-operation dispatch unit dispatches micro-operations to the scheduler queue. The first picker picks an oldest micro-operation that is ready for issue from the first set of entries in the scheduler queue in a picking cycle. The second picker picks an oldest micro-operation that is ready for issue from the second set of entries in the scheduler queue in the picking cycle. The scheduler queue issues the picked micro-operation from the first set of entries in the picking cycle and issues the picked micro-operation from the second set of entries in the picking cycle. In an implementation, the scheduler queue is a single queue structure. In an implementation, the first picker and the second picker block the picked micro-operation from the first set of entries and the picked micro-operation from the second set of entries from being picked in a next picking cycle. In an implementation, the scheduler queue generates a ready vector from micro-operations remaining in the scheduler queue from both the first set of entries and the second set of entries. In an implementation, the processor further includes a third picker that picks an oldest micro-operation that is ready for issue from the ready vector in the picking cycle. In an implementation, the first picker, the second picker and the third picker block the picked micro-operation from the first set of entries, the picked micro-operation from the second set of entries and the picked micro-operation from the ready vector from being picked in a next picking cycle. In an implementation, the scheduler queue issues the picked micro-operation from the ready vector in a next picking cycle. In an implementation, the first set of entries are even entries and the second set of entries are odd entries. In an implementation, non-overlapped is based on at least one of priority, historical data, and queue position. In an implementation, the scheduler queue is an address generation scheduler queue.

In general, a method for processing micro-operations includes dispatching micro-operations to at least one scheduler queue. A first oldest micro-operation that is ready for issue from the at least one scheduler queue is picked in a picking cycle, a second oldest micro-operation that is ready for issue from the at least one scheduler queue is picked in the picking cycle and at least one further oldest micro-operation that is ready for issue from the at least one scheduler queue is picked in the picking cycle. The picked first oldest micro-operation is issued in the picking cycle, the picked second oldest micro-operation is issued in the picking cycle, and the picked at least one further oldest micro-operation is issued in a next picking cycle.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for processing micro-operations, the method comprising:
dispatching micro-operations to a scheduler queue, the scheduler queue having a first set of entries and a second set of entries which are non-overlapped;
picking, in a picking cycle, an oldest micro-operation that is ready for issue from the first set of entries in the scheduler queue;
picking, in the picking cycle, an oldest micro-operation that is ready for issue from the second set of entries in the scheduler queue;
issuing, in the picking cycle, the picked micro-operation from the first set of entries; and
issuing, in the picking cycle, the picked micro-operation from the second set of entries.

2. The method of claim 1, wherein the scheduler queue is a single queue structure.

3. The method of claim 1, further comprising:
blocking the picked micro-operation from the first set of entries and the picked micro-operation from the second set of entries from being picked in a next picking cycle.

4. The method of claim 1, further comprising:
generating a ready vector from micro-operations remaining in the scheduler queue from both the first set of entries and the second set of entries.

5. The method of claim 4, further comprising:
picking, in the picking cycle, an oldest micro-operation that is ready for issue from the ready vector.

6. The method of claim 5, further comprising:
blocking the picked micro-operation from the first set of entries, the picked micro-operation from the second set of entries and the picked micro-operation from the ready vector from being picked in a next picking cycle.

7. The method of claim 5, further comprising:
issuing, in a next picking cycle, the picked micro-operation from the ready vector.

8. The method of claim 1, wherein non-overlapped is based on at least one of priority, historical data, and queue position.

9. The method of claim 1, wherein the scheduler queue is an address generation scheduler queue.

10. A processor for processing micro-operations, comprising:
a micro-operation dispatch unit;
a scheduler queue, the scheduler queue having a first set of entries and a second set of entries which are non-overlapped;
a first picker; and
a second picker,
wherein:
the micro-operation dispatch unit is configured to dispatch micro-operations to the scheduler queue,
the first picker is configured to pick, in a picking cycle, an oldest micro-operation that is ready for issue from the first set of entries in the scheduler queue;
the second picker is configured to pick, in the picking cycle, an oldest micro-operation that is ready for issue from the second set of entries in the scheduler queue;
the scheduler queue is configured to issue, in the picking cycle, the picked micro-operation from the first set of entries; and
the scheduler queue is configured to issue, in the picking cycle, the picked micro-operation from the second set of entries.

11. The processor of claim 10, wherein the scheduler queue is a single queue structure.

12. The processor of claim 10, wherein:
the first picker is configured to block the picked micro-operation from the first set of entries from being picked in a next picking cycle; and
the second picker is configured to block the picked micro-operation from the second set of entries from being picked in the next picking cycle.

13. The processor of claim 10, wherein:
the scheduler queue is configured to generate a ready vector from micro-operations remaining in the scheduler queue from both the first set of entries and the second set of entries.

14. The processor of claim 13, further comprising:
a third picker configured to pick, in the picking cycle, an oldest micro-operation that is ready for issue from the ready vector.

15. The processor of claim 14, wherein:
the first picker is configured to block the picked micro-operation from the first set of entries from being picked in a next picking cycle;
the second picker is configured to block the picked micro-operation from the second set of entries from being picked in the next picking cycle; and
the third picker is configured to block the picked micro-operation from the ready vector from being picked in the next picking cycle.

16. The processor of claim 14, wherein:
the scheduler queue is configured to issue, in a next picking cycle, the picked micro-operation from the ready vector.

17. The processor of claim 10, wherein non-overlapped is based on at least one of priority, historical data, and queue position.

18. The processor of claim 10, wherein the scheduler queue is an address generation scheduler queue.

19. A method for processing micro-operations, the method comprising:
dispatching micro-operations to at least one scheduler queue;
picking, in a picking cycle, a first oldest micro-operation that is ready for issue from the at least one scheduler queue;
picking, in the picking cycle, a second oldest micro-operation that is ready for issue from the at least one scheduler queue;
picking, in the picking cycle, at least one further oldest micro-operation that is ready for issue from the at least one scheduler queue;
issuing, in the picking cycle, the picked first oldest micro-operation; and
issuing, in the picking cycle, the picked second oldest micro-operation.

20. The method of claim 19, further comprising:
issuing, in a next picking cycle, the picked at least one further oldest micro-operation.
